(19) United States
(12) Patent Application Publication
(10) Pub. No.: US 2004/0026949 A1
(43) Pub. Date: Feb. 12, 2004

(54) Electric mobility scooter storage room

(76) Inventor: Chun-Moun Lin, Kaohsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/215,001

(22) Filed: Aug. 9, 2002

(51) Int. Cl. B60R 5/00

(52) U.S. Cl. 296/37.1

(57) ABSTRACT

An electric mobility scooter with a storage room comprises a holder, a hood, a lid, a pair of rear wheels, a seat, a battery, a motor and a scooter body, the battery is located in the center position of the scooter, and the motor is placed next to the battery and between the rear wheels, the holder with the hood are located on top of the motor, and the seat is located above the hood. The hood has an opening at the rear end as the door to place things in the storage room therein.

### BACKGROUND OF THE INVENTION

This invention relates to an electric mobility scooter storage room, more particularly to an electric mobility scooter with a storage space.

An electric mobility scooter plays an important role in our daily life due to the air pollution problem caused by fuel engine, furthermore, the fuel engine vehicle has a higher seat position and the engine runs too fast, which is not appropriate to an elder or a disabling rider.

An electric mobility scooter is therefore invented, however, this design is equipped with a large power battery to drive the motor, which is in a vertical position located in the scooter. In this case, the motor is higher than the battery along with the lower seat design, there is little space to store personal things. In many cases a user has to hang a basket on the front or the rear of the vehicle.

In view of this, the inventor has invented the present invention to improve the above shortcomings.

### SUMMARY OF THE INVENTION

It is the primary object of the present invention to provide an electric mobility scooter with a storage room, which has a storage space to store personal things.

It is another object of the present invention to provide an electric mobility scooter with a storage room, which is convenient and safer to a driver.

### BRIEF DESCRIPTION OF THE DRAWINGS

FIG. 1 is an exploded view of the present invention;

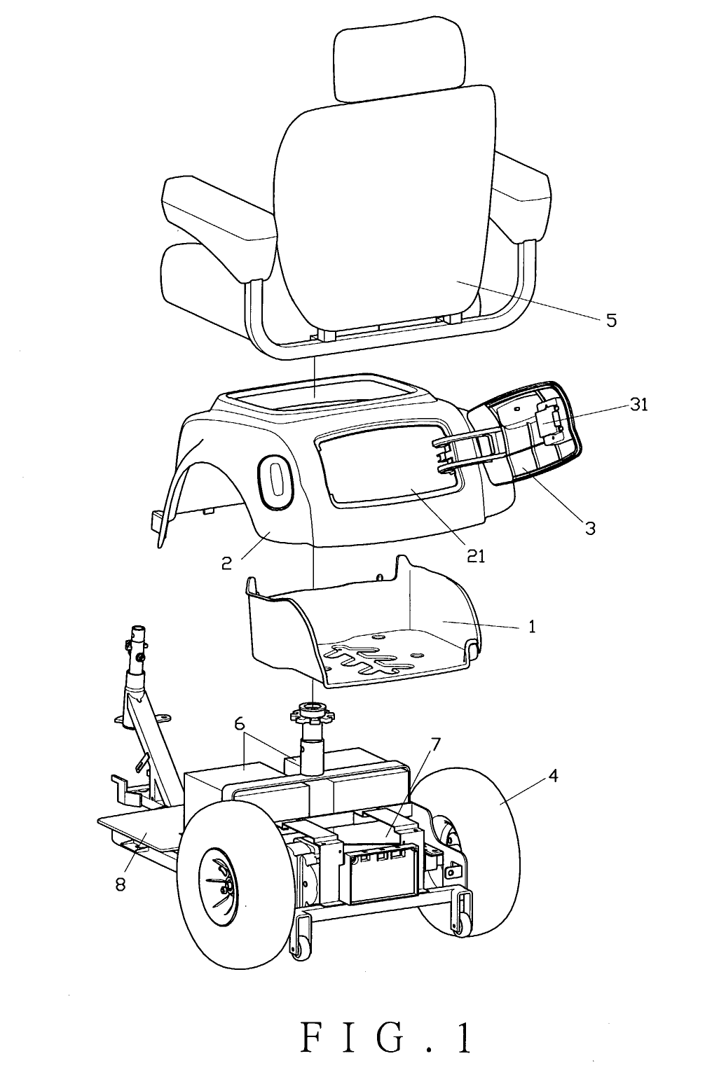

FIG. 2 is a perspective view of the present invention; and

FIG. 3 is a perspective view similar to FIG. 2 with a door in an open status.

### DETAILED DESCRIPTION OF THE PREFERRED EMBODIMENT

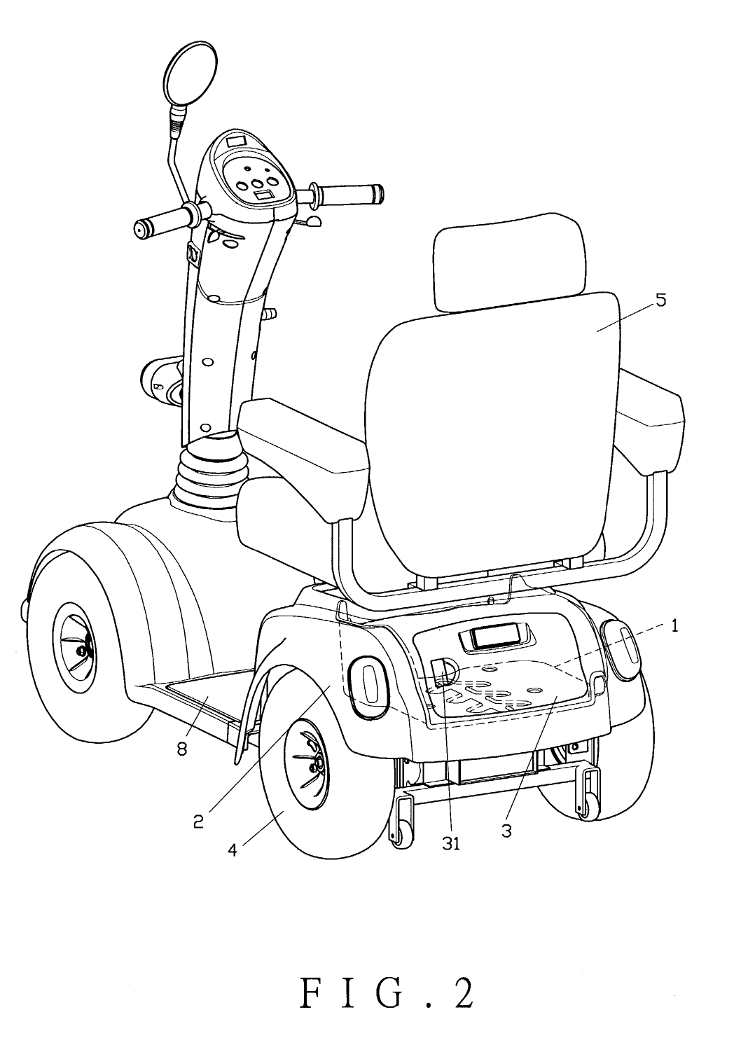

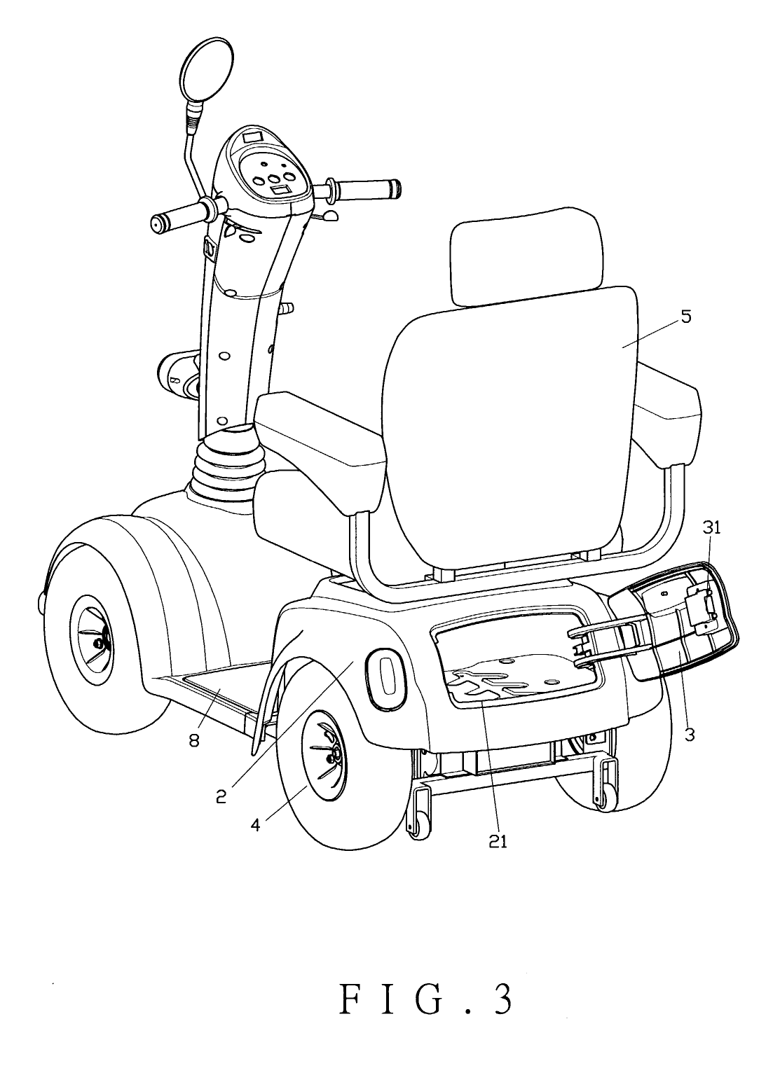

As shown in FIGS. 2 and 3, the electric mobility scooter with a storage room of the present invention comprises a holder 1, a hood 2, a lid 3, a pair of rear wheels 4, a seat 5, a battery 6, a motor 7 and the body 8 of the scooter.

The holder 1 is a flat board with three side walls erected upwardly in a 90 degree from the board. The hood 2 has an opening 21 at its rear end and is covered by the lid 3 which is hinged to one side of the opening 21 and comprises a hook 31 to enclose the opening 21.

The battery 6 is located on the center position of the body 8. The motor 7 is secured on the body 8 next to the battery 6 and between the rear wheels 4. The holder 1 is secured on the top of the motor 7, and the hood 2 covers the holder 1 and the battery 6. The lower portion of the hood 2 is securely fixed on the body 8 by means of threads or clips. A convenient storage room is formed between the holder 1 and the hood 2.

As shown in FIG. 3, the lid 3 is in an open status, which discloses the storage room, and the lid 3 may be closed by means of the hook 31 to engage with the opening 21 to prevent personal things from loosening.

I claim:

1. An electric mobility scooter with a storage room comprising a holder, a hood, a lid, a pair of rear wheels, a seat, a battery, a motor and a scooter body, whereas said battery being located on the center position of said scooter, said motor being located next to said battery and between said rear wheels, and being characterized by that
said holder being located on top of said motor and behind said battery, and said hood being located above said holder and covering said holder and said battery, and said seat being on the top of said hood, said hood comprising an opening at the rear end of said hood, whereas said holder and said hood being placed on top of said motor and underneath said seat to form a storage room.

2. The electric mobility scooter with a storage room, as recited in claim 1, wherein said opening of said hood has a lid at one side.
